(19) United States
(12) Patent Application Publication
(10) Pub. No.: US 2003/0140802 A1
(43) Pub. Date: Jul. 31, 2003

(54) Postage assembly

(76) Inventor: Jonathan Beach, Miami, FL (US)

Correspondence Address: MALLOY & MALLOY, P.A., 2800 S.W. Third Avenue, Historic Coral Way, Miami, FL, 33129, US

(21) Appl. No.: 10/062,146

(22) Filed: Jan. 31, 2002

(51) Int. Cl. B41D 7/00

(52) U.S. Cl. 101/33

(57) ABSTRACT

A postage assembly structured to define or be representative of the charge for mailing an article and including a display field positioned on an exposed portion of the article being mailed. A graphic presentation and at least one commercial segment are cooperatively disposed for viewing in an observable location on or within the display field, wherein at least the one commercial segment comprises an advertising display. The display field, graphic presentation and one or more commercial segments may be visually integrated on a base which is structured to be mounted on the mail article by an adhesive or like material backing or by being imprinted thereon.

### BACKGROUND OF THE INVENTION

1. Field of the Invention

This invention relates to a postage assembly which is representative of the money amount charged for mailing an article. The postage assembly includes a viewable display field which comprises at least one commercial segment including an advertisement, observably integrated in the postage assembly so as to be considered a part thereof.

2. Description of the Related Art

Postage is recognized as a money charge or cost for an article being collected, distributed and otherwise processed by an authorized postal service and is a requisite for the mailing of an article within the United States and other countries. Since the use of postage stamps began centuries ago, they have included pictorial displays and graphic representations representative of a variety of subjects. These vary from simple graphics, such as a flag, to representative portraits commemorating famous people.

In typical fashion postage stamps are secured to the exterior of a letter, parcel or other mail article. In order to accommodate mail articles of varying weight, dimension, etc. and based on the type of mail service requested, the amount of money charged to mail an article may vary significantly. Accordingly, stamps of varying denomination are made commercially available. Subsequent to purchase, an individual will affix one or more stamps which individually or collectively represent the amount of money charged for processing the mail article by the postal service.

Because the amount of postage may vary, as set forth above, there is a recognized inconvenience in an individual maintaining a plurality of stamps of varying denomination in order to correctly apply the amount of postage to one or more articles being mailed. Still, pre-printed stamps are currently the most common way in which mail from private individuals are sent to their destination. However, at least partially due to such inconvenience and also because of cost, metered stamps are the most common way for large and small businesses and a variety of other organizations to send mail to the intended destination. As a result, metering devices or machines are available, wherein the exact amount of postage can be printed on the exterior surface of the article being mailed or on a mailing label to be attached thereto. Similarly, technological advancements in personal computers and processors allow an individual to print postage which is either adhesively applied or imprinted directly on the envelope or exterior surface portion of the article being mailed.

The volume of mail processed by the postal service in the United States totals into the millions on a daily basis. In performing the collection, sorting, distribution, etc. of the various pieces of mail being processed, many different individuals repeatedly view numerous pieces of mail every day. More specifically, mail articles are viewed by many individuals other than the sender or individual or other entity to which the mail article is being sent.

In commerce as practiced by many industrialized countries throughout the world, advertising is an integral and important part of every day life. As such, numerous products and services are brought to the attention of the consuming public utilizing various forms of advertisements. Depending on the method of advertisement and on the number of consumers exposed thereto, the commercial success or failure of a product may be directly proportional to the quality, quantity and cost of corresponding advertisement. Moreover, billions of dollars are spent each year for advertising various goods through the conventional advertising media. Such media includes radio, television, newspapers, magazines, coupons, flyers, etc.

While such advertising media is effective to varying degrees, advertisers are continuously looking for new ways to present goods and services to potential consumers. A prime consideration in the purchase, format and dissemination of advertisement is the cost involved and the size of the potential market interested in the purchasing of a given product or service. In addition, the general public as well as specific consumer groups have been exposed to conventional advertising media on such a repetitive basis that the desired or intended effect of the advertisement is sometimes lessened.

In an effort to go beyond the commonly recognized forms of advertisement, as generally outlined above, there have been attempts to take advantage of the exposure to the public of the extremely high volume of mail processed on a daily basis. Such known attempts have included the design and structuring of labels which include an exposed surface having one or more advertising displays formed thereon. These known label structures include a separate, segregated space located on a front face or exposed surface which is dimensioned, configured and otherwise structured to facilitate the mounting of a postage stamp thereon. Once secured, the advertising label and affixed postage stamp is secured in its entirety to an article intended to be mailed by adhesive or other appropriate means.

Typically, known attempts of this type result in the advertising display physically and visually overwhelming the stamp or other form of postage. It is therefore difficult if not impossible to recognize, locate and “read” the value denomination of the stamp such as when using automatic and/or optical reader devices commonly installed in mail processing facilities. In addition, known advertising displays of the type described herein are not structured to accommodate a plurality of postage stamps which are frequently necessary when applying the required amount of postage. Also, advertising displays are not readily adaptable to “metered mail” or custom printed postage of the type generated by personal computers.

Accordingly, a postage assembly which represents a novel form of advertisement while simultaneously serving as authorized postage by postal authorities throughout the world would be highly desirable. In addition the adding of advertisements to some, if not all, of the various forms of postage currently being used in the United States, as well as other countries throughout the world, could possibly serve as an added source of revenue to the authorizing postal department.

In addition, an improved postal assembly would be capable of reaching literally millions of people on a daily basis in a manner which would not raise the cost of the postage beyond the intended value denomination thereof. Further, the versatility in the design and structuring of such an improved postage assembly would allow it to be available to the consuming public in a conventional “postage stamp”. Alternatively the improved postage assembly could be printed on the exterior surface of the letter or other mail article being processed utilizing metering facilities and/or a computer/processor, as set forth above. Also, the processing of the various mail articles on which such an improved postage assembly is mounted could be accomplished using conventional and existing automatic and/or optical reading equipment which determines that the correct value of postage is placed on the individual articles being mailed.

### SUMMARY OF THE INVENTION

The present invention is directed to a postage assembly which defines and/or is representative of authorized postage including the cost and/or charges for mailing an article on which the postage assembly is mounted. As such, the postage assembly of the present invention may be made commercially available in a number of different denominations or values. In addition, the postage assembly of the present invention is mounted on or affixed to an exposed, exterior surface of the mail article. As used herein, the term “mail article” is meant to be descriptive in the broadest sense of any envelope, parcel, package or like object which is intended to be mailed in the conventional fashion and which includes physical and dimensional parameters acceptable to the postal service processing the mail article.

More specifically, at least some of the preferred embodiments of the postal assembly of the present invention include a base which may be defined by an independent, separately structured member capable of being affixed to the exposed surface of the mail article being processed. The mounting of the base may be accomplished in a known or conventional fashion, such as by the use of an adhesive backing on the rear or under surface of the base. The outer face or exposed surface comprises physical borders within which is disposed a display field. As such, the base and display field structurally represent a “stamp” which may be mounted on or affixed to the mail article, as described above.

Alternatively, the base as well as the display field may comprise a printed structure which is affixed to the mail article being processed by imprinting the base and the display field. Creation and affixation of the base and display field in this manner may be accomplished by a metering device or machine or alternatively by means of a personal computer or like computer/processor structure comprising a program for the creation of postage, as is now technologically available and known. Accordingly, the term “base” is not meant to exclusively describe a separate, stamp like object or structure which may only be affixed to the mail article in the manner described above. To the contrary, the term “base” is also meant to be descriptive of the overall structure of the postage assembly mounted on the mail article by imprinting or by other means such as by generating postage utilizing a personal computer or like processor.

In addition, one feature of the various preferred embodiments of the postage assembly of the present invention comprises a display field including a graphic presentation visually integrated therein and disposed in a clearly observable location on the outer face of the base. The graphic presentation may take the form of a pictorial display, indicia, flag, portrait, or any other visual presentation comprising words or scenes or a combination thereof as desired by the creator of the graphic presentation. In addition, the display field also includes at least one commercial segment cooperatively disposed relative to the graphic presentation and the display field so as to be clearly observable when viewing the postage assembly.

As will be explained in greater detailed hereinafter, in a most preferred embodiment of the subject postage assembly, the commercial segment comprises an advertising display. In addition, the commercial segment may be specifically integrated into the graphic presentation such that the commercial segment and the graphic presentation may comprise related subject matter, related commercial subject matter, common commercial subject matter and/or a combination thereof which facilitates the advertising of a product, service and/or a common entity or different entities. Further, the size, dimension and configuration of each of the graphic presentations and the commercial segment may vary. By way of example, the graphic presentation may comprise a majority of the exposed area of the display field and the commercial segment may be in the form of an overlay or banner type of configuration. As such, the commercial segment is disposed within the display field and in somewhat overlying relation to the graphic presentation.

In contrast the versatility of the postage assembly of the present invention may be such that the commercial segment and the graphic display are effectively viewed as one in the same since both relate to a common commercial subject matter serving to advertise at least one entity, product or service. In such an embodiment the commercial segment and graphic presentation are difficult, if not impossible, to visually distinguish from one another. Further by way of example, this latter described embodiment may include a pictorial representation of a product viewed in a common, commercial environment wherein the name, logo, or symbol of the product representing the commercial segment is directly integrated into the overall pictorial representation. The commercial segment would therefore be effectively indistinguishable from the product and/or the surrounding commercial environment in which the product is depicted.

As a second example, the commercial segment and the graphic presentation can be clearly distinguishable from one another, wherein the commercial segment is depicted as an advertising display and the graphic presentation is depicted as a related or non-related environment. As such, the commercial segment may be an automobile and/or a logo type commercial symbol of an automobile visually integrated into a highway or roadway scene defining the graphic presentation. In this example, the scenic highway or roadway does not in and of itself represent a related or common commercial presentation but merely a natural environment in which the product (automobile) can be found in every day life.

Also more than one commercial segment may be integrated into the display field in cooperative relation to the graphic presentation. As yet another example, an automobile maintenance company or franchise could define one of a plurality of commercial segments, wherein such maintenance facility advertises the use of a specific product such as oil, cleaners, gasoline, etc. As such, two distinguishable entities are defined by two, or more commercial segments both of which may correspond both in content and relative physical location with the graphic presentation defined within the display field.

Therefore, the postage assembly of the present invention incorporates the advertising of one or more products, services, entities, etc. directly on the base and more particularly within a display field. In doing so millions of people would be exposed to the advertising depicted within the postage assembly of the present invention without significantly adding to the cost of the postage assembly. Also the public will be exposed to an advertising media which significantly differs from the more common types of advertising displays in that consumers are not use to viewing advertising in direct association with postage appearing on any of a variety of mail articles.

Finally, the addition of various types of advertisements to authorized postage could possibly result in a significant source of additional income, not previously available to the various postal services around the world. In turn, such additional income could be of benefit to the general population of the various countries, since it is well recognized that the U.S. and other postal services have typically operated at substantial deficit for many years.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front plan view of a mail article in the form of an envelope including a postage assembly of the present invention mounted on an exposed surface thereof.

FIG. 2 is a front plan view of one preferred embodiment of the postage assembly of the present invention.

FIG. 3 is a front plan view of yet another preferred embodiment of the postage assembly of the present invention.

FIG. 4 is a front plan view of yet another preferred embodiment of the postage assembly of the present invention.

FIG. 5 is a front plan view of yet another preferred embodiment of the postage assembly of the present invention.

FIG. 6 is a front plan view of yet another preferred embodiment of the postage assembly of the present invention.

FIG. 7 is a front plan view of yet another preferred embodiment of the postage assembly of the present invention.

Like reference numerals refer to like parts throughout the several views of the drawings.

### DETAILED DESCRIPTION OF THE PREFERRED EMBODIMENT

As shown in the accompanying drawings, the present invention is directed to a postage assembly, wherein the various preferred embodiments are each generally indicated as 10. The postage assembly 10, in typical fashion, is intended to be mounted or secured to a mail article generally indicated as 12 such as on an exposed surface 14 thereof. As will be explained in greater detail hereinafter, the postage assembly 10 includes a base 16 which may assume a variety of different structures.

More specifically, the base 16 may be an independent object or “stamp like” structure which may be secured to the exposed surface 14 of the mail article 12 such as by an adhesive backing or other means of securement. Alternatively, the term “base” is meant to be descriptive, in the broadest sense, of the postage assembly 10 being imprinted on the exposed surface 14 or on an independent label 15 which itself is secured to the exposed surface 14. Moreover, the base 16 can be generated or produced by a personal computer or like processor having an appropriate postage generating program downloaded thereon. As such the base 16 of the postage assembly 10 may be generated directly on the exposed surface 14 of a mail article or on an attachable label 15, as set forth above.

Further, it is emphasized that the term “mail article” is meant to be descriptive of any envelope, parcel, package or like object having the physical parameters which allow it to be accepted and processed by a given postal facility such as, but not limited to, the United States postal service.

It should also be noted that the base 16 may include a border or peripheral portion 18 having a variety of different structures, dimensions and configurations. As represented in at least some of the accompanying Figures, the border 18 has a substantially “serrated” configuration which may facilitate a plurality of the bases 16 of a plurality of assemblies 10 being removably secured to one another along correspondingly disposed weakened, interconnecting edges 19. Also, while the various preferred embodiments of the present invention are represented as having a square, rectangular or multi-sided configuration, it is emphasized that the overall dimension and configuration of the postage assembly 10 may vary and assume other than a multi-sided configuration, not being limited to a square or rectangular shape.

Another structural feature of the various preferred embodiments of the present invention include the provision of a display field generally indicated as 20. The display field 20 is maintained within the physical boundaries defined by the border 18. However, the variations of the display field 20 to be included within the spirit and scope of the present invention is the expansion of the display field 20 to cover substantially all of the exposed area or surface on the front face of the base 16 rather than having its periphery contiguous with the border 18. Regardless of the specific embodiment, the display field 20 extends over at least a majority of the exposed face of the base 16 in order to provide an attractive, noticeable, observable display contained within the display field 20.

The display field 20 comprises a graphic presentation generally indicated as 22 and a commercial segment generally indicated as 24 both visually integrated within the display field 20 as shown throughout FIGS. 2 through 7. As will be explained in greater detail hereinafter, the commercial segment 24 is preferably presented in the form of an advertising display. As such the advertising display of the commercial segment 24 may be in the form of a logo, words, pictures, designs, and/or a variety of other indicia and is not necessarily limited to an alpha-numeric presentation.

The graphic presentation 22 is also integrated into the display field 20 and may comprise a pictorial or other graphic representation. Such additional graphic representation may include a portrait, flag, object, scenery, picture, setting, background, etc. As represented in the various preferred embodiments of FIGS. 2 through 7, commercial segment 24 preferably includes an advertising display. However, the graphic representation 22 and more particularly the visual representation defining the graphic presentation 22 may be related subject matter, related commercial subject matter, common subject matter, common commercial subject matter, representing advertising of the same entity and/or of different entities, all of which will be explained in greater detail hereinafter.

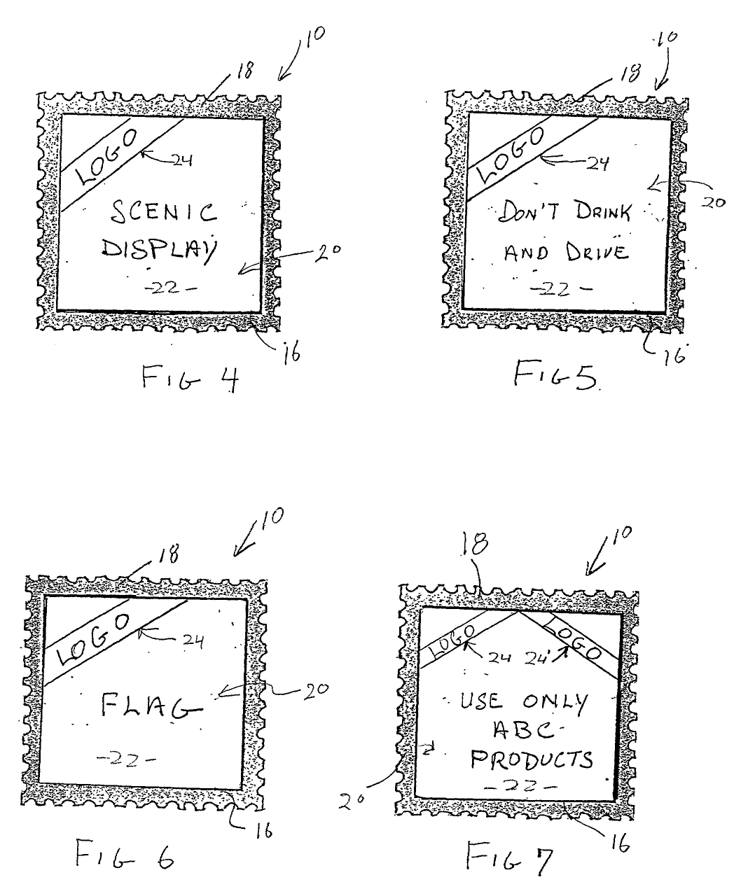

By way of example only, and with reference to FIG. 4 the commercial segment 24 preferably comprises a logo, name symbol, etc defining an advertising display. However, the graphic presentation 22 merely represents an attractive scenic display or other pictorial display or indicia which is not related to the advertising display of the commercial segment 24 but which presents a generally pleasant and attractive scene.

FIG. 5 shows the commercial segment 24 in the form of an advertising display such as a logo, name, etc. The graphic presentation 22 while relating to commercial subject matter which may be related to the product or service being advertised by the commercial segment 22 does not in and of itself present an advertising display or advertisement. For example, the commercial segment 24 may represent the logo, symbol, name, etc. of an automobile or other motorized vehicle or of an alcoholic beverage or the like. A commercial and generally related subject matter of the graphic presentation 22 could be safety instructions such as “don't drink and drive”.

In the embodiment of FIG. 6, the commercial segment 24 is in the form of a preferred advertising display including the logo, name, indicia, etc. representative of a product or service. In contrast, the graphic presentation 22 may be totally unrelated and be clearly visually distinguishable such as being in the form of a national or state flag, portrait of an historic person, or a variety other non-related non-commercial subject matters.

The embodiment of FIG. 7 discloses a plurality of commercial segments 24 and 24′, as set forth above. In addition, the graphic presentation 22 can be an advertisement of another product or service by an entity which differs from the entity represented in the advertising display of either of the logo commercial segments 24, 24′. By way of example, numerous franchise organizations, while advertising their own service or product, also present concurrent or simultaneous advertisements of products used or sold by a given entity. Accordingly, the embodiment of FIG. 7 represents both the graphic presentation 22 and each one or both of the commercial segments 24, 24′ depicting common commercial subject matter representing different entities wherein the entities may represent the source of origin of the product of service or the product service itself.

In the embodiment of FIG. 2, the graphic presentation 22 may represent a related, or non-related commercial scene such as the depiction of an airplane flying over a picturesque site. The commercial segment 24 may be defined by an advertising display representative of the make or model or origin of the airplane 22′ or of a totally different entity, product, service, etc. not related to or common with the airplane 22′ and/or a scene extending over a majority of the graphic presentation 22.

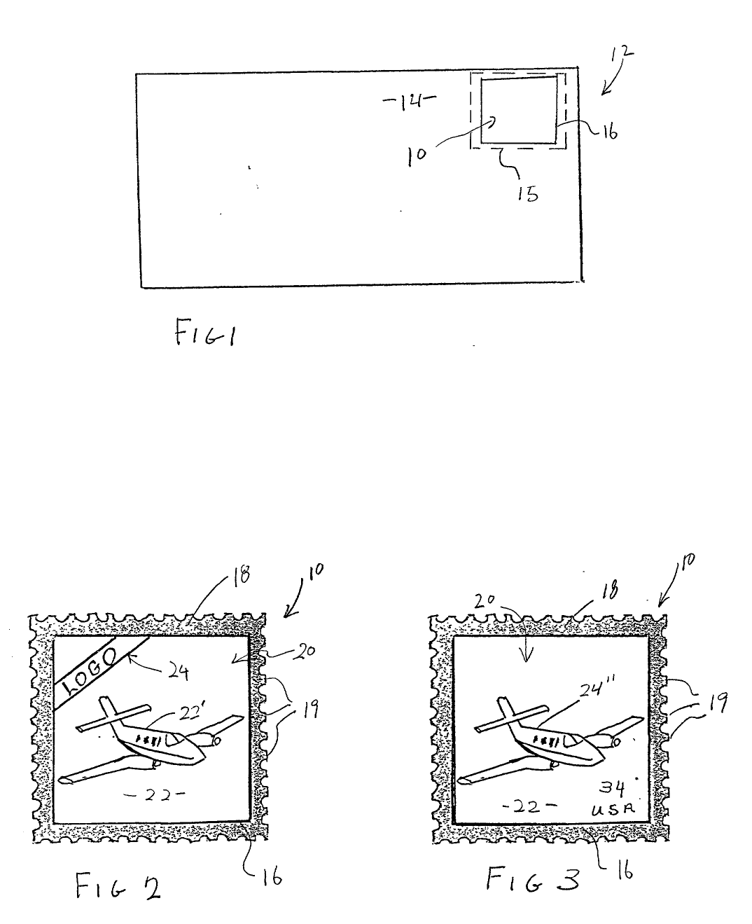

The embodiment of FIG. 3 comprises a graphic presentation and the commercial segment 24″ being one in the same and therefore being substantially visually indistinguishable. As such, the advertising display may be that of an airplane including the make, model, origin, etc. which extends over the majority, if not the entire pictorial representation of the graphic presentation 22.

For purposes of convenience the commercial segment 24, in many of the preferred embodiments of FIGS. 1 through 7 is represented by an overlay structure generally having a “banner” configuration or presentation. It is emphasized that the commercial segment 24 may include a variety of different presentations other than a banner or overlay segment such as being integrated directly into the graphic presentation of 22 as at least partially explained with the embodiment of FIG. 3 or may be an integrated into the scene, display, picture, etc. of the graphic presentation 22. Again with reference to FIG. 3 the commercial segment 24′ may comprise at least the majority or substantially all of the display field 20 since the entire scene defining the graphic presentation 22 is representative of the aforementioned advertising display rather than just the depiction of the airplane 24″ itself.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A postage assembly structured to be mounted on a mail article, said postage assembly comprising:
a) a display field positioned on an exposed portion of the mail article,
b) a graphic presentation and at least one commercial segment cooperatively disposed in an observable location from an exterior of the mail article, and
c) a base structured to include said graphic presentation and said commercial segment visually integrated in said display field.

2. A postage assembly as recited in claim 1 wherein said commercial segment comprises an advertising display.

3. A postage assembly as recited in claim 2 wherein said graphic presentation and said commercial segment are visually distinguishable from one another.

4. A postage assembly as recited in claim 1 wherein said graphic presentation and said commercial segment are visually distinguishable from one another.

5. A postage assembly as recited in claim 4 wherein said graphic presentation and said commercial segment each include related subject matter.

6. A postage assembly as recited in claim 5 wherein said graphic presentation and said commercial segment each include related commercial subject matter.

7. A postage assembly as recited in claim 6 wherein said commercial segment comprises an advertising display.

8. A postage assembly as recited in claim 4 wherein said graphic presentation and said commercial segment each include common commercial subject matter.

9. A postage assembly as recited in claim 8 wherein said common commercial subject matter comprises advertising of a common entity.

10. A postage assembly as recited in claim 8 wherein said common commercial subject matter comprises advertising of different entities.

11. A postage assembly as recited in claim 4 wherein said graphic presentation and said commercial segment comprise non-related subject matter.

12. A postage assembly as recited in claim 4 wherein at least the majority of said display field is defined by said graphic presentation.

13. A postage assembly as recited in claim 12 wherein said commercial segment comprises an overlay portion disposed substantially within said graphic presentation.

14. A postage assembly as recited in claim 12 wherein said commercial segment comprises a banner disposed in overlying relation to at least a portion of said graphic presentation.

15. A postage assembly as recited in claim 4 wherein at least a majority of said display field is defined by said commercial segment.

16. A postage assembly as recited in claim 1 further comprising a plurality of commercial segments disposed on said base, each of said plurality of commercial segments including an advertising display collectively positioned to define at least a portion of said display field.

17. A postage assembly structured to be mounted on a mail article, said postage assembly comprising:
a) a graphic presentation disposed on an expose portion of the mail article,
b) a commercial segment cooperatively disposed in an observable location relative to said graphic presentation, and
c) a display field comprising said graphic presentation and said commercial segment and structured to substantially define the viewable confines thereof.

18. A postage assembly as recited in claim 17 further comprising a base having said display field formed thereon, said base securable to the mail article.

19. A postage assembly as recited in claim 18 wherein said base includes an adhesive material backing.

20. A postage assembly as recited in claim 18 wherein said base is substantially permanently affixed to the mail article.

21. A postage assembly as recited in claim 20 wherein said base is printed on the mail article.

22. A postage assembly as recited in claim 17 wherein said graphic presentation and said commercial segment are visually distinguishable from one another.

23. A postage assembly as recited in claim 22 wherein said commercial segment comprises an advertising display.

24. A postage assembly as recited in claim 17 wherein said graphic presentation and said common segment are substantially visually in distinguishable from one another and collectively define an advertising display.

25. A postage assembly as recited in claim 24 wherein said graphic presentation and said commercial segment collectively extend over substantially an entire exposed area of said display field.

26. A postage assembly as recited in claim 17 further comprising a value indication cooperatively disposed in an observable location relative to said display field.

27. A postage assembly as recited in claim 26 wherein said graphic presentation is printed on said base within said display field.

28. A postage assembly as recited in claim 27 wherein said commercial segment is printed on said base in cooperative, viewable relation to said graphic presentation.

29. A postage assembly as recited in claim 27 wherein said commercial segment comprises a overlay structure secured in a viewable location to said graphic presentation.
